(19) United States
(12) Patent Application Publication
(10) Pub. No.: US 2026/0094210 A1
(43) Pub. Date: Apr. 2, 2026

(54) PROCESSING HOLDINGS DATA OF A PORTFOLIO MANAGER

(71) Applicant: Essentia Analytics Ltd., London (GB)

(72) Inventors: Clare Pauline Flynn Levy, Old Greenwich, CT (US); Christopher Woodcock, London (GB)

(21) Appl. No.: 18/901,796

(22) Filed: Sep. 30, 2024

(51) Int. Cl. G06Q 40/06

(52) U.S. Cl. CPC G06Q 40/06

(57) ABSTRACT

A method and system for processing holdings data of a portfolio manager. The method includes receiving holdings data of the portfolio manager, transforming the holdings data into episode data using a first machine learning algorithm, identifying one or more decisions made by the portfolio manager from the episode data based on a second machine learning algorithm, and determining a decision type of the one or more decisions. The decision type is one of instrument picking, entry timing, sizing, scaling in, size adjusting, scaling out, and exit timing. The method further includes generating insights based on the one or more decisions, the decision type, and a decision score of the one or more decisions, and generating nudges and a performance score for the portfolio manager based on the insights and the decision score.

### FIELD OF INVENTION

The present disclosure relates to systems and methods for investment data analysis, and more particularly to a method and system for conversion of investment data into processable and insightful data.

### BACKGROUND

Investment portfolio management involves complex decision-making processes that significantly impact financial outcomes. Traditional methods of evaluating portfolio manager performance often fail to provide granular insights into the effectiveness of specific decisions made throughout the investment lifecycle. This lack of detailed analysis makes it challenging to identify areas for improvement and optimize investment strategies.

Currently, portfolio performance evaluation typically relies on broad metrics such as overall returns, risk-adjusted measures, and benchmark comparisons. While these methods offer a high-level view of performance, they do not adequately capture the nuanced decision-making process of portfolio managers. Existing solutions may track basic trade data or holdings information, but they struggle to contextualize this data within the broader investment strategy and market conditions. Existing solutions use software to compare returns of a portfolio manager's investments with a benchmark. These software analyse the investments of the portfolio manager and not the decisions.

The limitations of current approaches present several challenges. First, they often fail to distinguish between different types of investment decisions, such as instrument selection, entry and exit timing, or position sizing because the traditionally used software fail to interpret decisions from the investment data. This lack of differentiation makes it difficult to assess a manager's skill in specific areas. Second, existing methods typically do not account for the dynamic nature of market conditions and how they influence decision-making. Finally, there is a lack of real-time, actionable insights that could help portfolio managers improve their strategies on an ongoing basis. These shortcomings highlight the need for more sophisticated, data-driven approaches to analyzing and enhancing portfolio management decisions.

### SUMMARY

Before the present system(s) and method(s), are described, it is to be understood that this application is not limited to the particular system(s), and methodologies described, as there can be multiple possible embodiments that are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for processing holdings data of a portfolio manager. This summary is not intended to identify essential features of the claimed subject matter, nor is it intended for use in determining or limiting the scope of the claimed subject matter.

According to an aspect of the present disclosure, a method for processing holdings data of a portfolio manager is provided. The method includes receiving, by a processor, holdings data of the portfolio manager. The method further includes transforming, by the processor, the holdings data into episode data using a first machine learning algorithm. The method also includes identifying, by the processor, one or more decisions made by the portfolio manager from the episode data based on a second machine learning algorithm. The method further includes determining, by the processor, a decision type of the one or more decisions, wherein the decision type is one of instrument picking, entry timing, sizing, scaling in, size adjusting, scaling out, and exit timing. The method also includes generating, by the processor, insights based on the one or more decisions, the decision type of the one or more decisions, and a decision score of the one or more decisions. The method further includes generating, by the processor, nudges and a performance score for the portfolio manager based on the insights and the decision score of the one or more decisions.

According to other aspects of the present disclosure, the method may include one or more of the following features. The episode data may comprise one or more episodes, wherein an episode from the one or more episodes comprise a plurality of decisions, wherein the one or more episodes are determined based on one or more parameters. The transforming the holdings data may further comprise enriching the episode data by adding at least one of market data, calculated metrics data, and island data. The calculated metrics data may comprise derived metrics calculated based on the holdings data and market data. The island data may be determined based on the holdings data and a machine learning algorithm. The one or more parameters may be predefined, and wherein the one or more parameters may include at least one of an entry time, an exit time, a holding threshold, and a holding period. The decision score may correspond to the impact on a portfolio of the portfolio manager, and wherein the decision score may be calculated based on the time-weighted return on investment of an instrument over a period of the episode. The decision score may be calculated based on the money-weighted return on investment of the instrument over the period of the episode. The period of the episode may correspond to the difference between the exit time and the entry time. The decision types may be determined by comparing the actual decisions with a baseline alternative. The insights may include a ranking of the portfolio manager's decision-making performance relative to other portfolio managers. The nudges may be personalized based on the portfolio manager's historical decision-making patterns. The performance score may be updated in real-time based on the portfolio manager's ongoing decisions. The insights may include an analysis of the portfolio manager's decision-making skill in different market conditions. The insights generated may include recommendations for improving future decision-making. The nudges generated may be real-time alerts provided to the portfolio manager. The performance score may be calculated based on a weighted average of the decision scores. The insights generated may include a comparative analysis of the portfolio manager's performance against a benchmark. The method may further comprise generating a visual representation of the decision types and their respective impacts on the portfolio value. The method may further comprise providing a historical analysis of the portfolio manager's decision-making patterns over a specified period. The first machine learning algorithm may be trained to detect one or more instruments in the holdings data, wherein the first machine learning algorithm may be trained to further detect episodes for the one or more instruments based on one or more triggers, and wherein the one or more triggers may comprise at least one of a buying decision, a selling decision, and a shorting decision. The first machine learning algorithm may be trained using a training dataset comprising at least one of a plurality of portfolios, corresponding holdings data for the plurality of portfolios, labelled episodes for one or more instruments in the corresponding holdings data, and labelled triggers for the labelled episodes.

According to another aspect of the present disclosure, a system for processing holdings data of a portfolio manager is provided. The system includes a processor and a memory storing instructions that, when executed by the processor, cause the system to: receive, using a data acquisition engine, daily holdings data of the portfolio manager; transform, using a transformation engine, the daily holdings data into episode data using a first machine learning algorithm; identify, using a detection engine, one or more decisions made by the portfolio manager from the episode data based on a second machine learning algorithm; determine, using a categorization engine, a decision type of each decision, wherein the decision type is one of instrument picking, entry timing, sizing, scaling in, size adjusting, scaling out, and exit timing; generate, using a recommendation engine, insights based on the identified decisions, the decision types, and a decision score; and generate, using an elicitation engine, nudges and a performance score for the portfolio manager based on the insights.

The foregoing general description of the illustrative embodiments and the following detailed description thereof are merely exemplary aspects of the teachings of this disclosure and are not restrictive.

### BRIEF DESCRIPTION OF FIGURES

The foregoing detailed description of embodiments is better understood when read in conjunction with the appended drawings. For the purpose of illustrating of the present subject matter, an example of a construction of the present subject matter is provided as figures, however, the invention is not limited to the specific method and system for processing holdings data of a portfolio manager disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

The figures depict an embodiment of the present disclosure for purposes of illustration only. One skilled in the art will readily recognize from the following discussion that alternative embodiments of the structures and methods illustrated herein may be employed without departing from the principles of the disclosure described herein.

FIG. 1 illustrates a system architecture for processing data, according to aspects of the present disclosure.

FIG. 2 depicts a flowchart of a method for processing holdings data of a portfolio manager, according to an embodiment.

FIG. 3 illustrates a system architecture diagram for processing holdings data of a portfolio manager, according to aspects of the present disclosure.

FIG. 4 depicts a flowchart of a process for transforming and enriching episode data, according to an embodiment.

FIG. 5 illustrates a neural network architecture for data processing, according to aspects of the present disclosure.

FIG. 6 depicts a three-dimensional representation of decision data, according to an embodiment.

### DETAILED DESCRIPTION

Some embodiments of this disclosure, illustrating all its features, will now be discussed in detail. The words “receiving,” “transforming,” “identifying,” “determining,” “generating,” and other forms thereof, are intended to be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present disclosure provides a system and method for analyzing investment portfolio decisions using machine learning techniques. This system and method may be capable of processing large volumes of holdings data from a portfolio manager, transforming this data into a format that captures the temporal nature of investment decisions, and identifying key decisions made by the portfolio manager. The system and method may also be capable of determining the type of each decision, which could include instrument picking, entry timing, sizing, scaling in, size adjusting, scaling out, and exit timing.

Furthermore, the system and method may generate insights based on these identified decisions, their types, and a decision score associated with each decision. These insights may provide valuable information about the portfolio manager's decision-making process and its impact on portfolio performance. Additionally, the system and method may generate nudges and a performance score for the portfolio manager based on these insights and decision scores. These nudges and performance score could provide real-time feedback to the portfolio manager, potentially aiding in future decision-making and improving overall portfolio performance.

In some aspects, the system and method may utilize a first machine learning algorithm to transform holdings data into episode data, and a second machine learning algorithm to identify decisions from the episode data. The machine learning algorithms may be trained on a variety of data, including historical holdings data, market data, and other relevant information. This approach may allow the system and method to adapt to changing market conditions and evolving investment strategies, providing robust and flexible support for portfolio management.

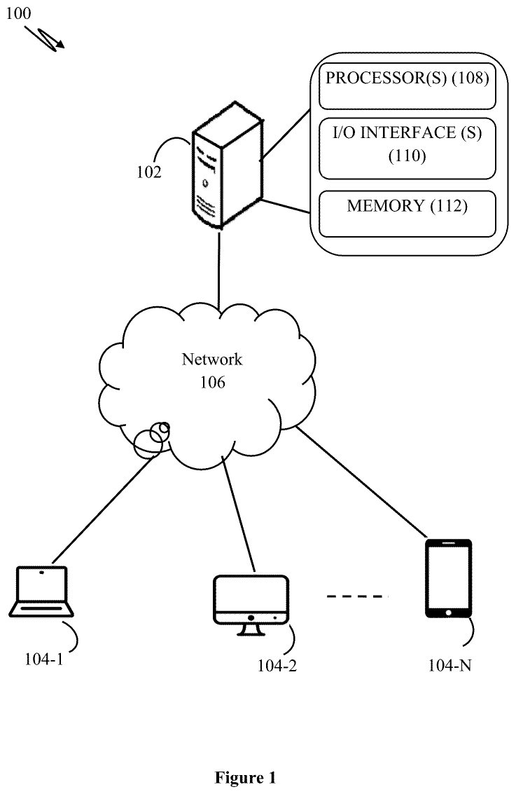

Referring to FIG. 1, an exemplary system architecture for processing data is depicted. The system may include a central server or computer system 102, which may be connected to a network 106. The central server or computer system 102 may include one or more processors 108, one or more I/O interfaces 110, and memory 112. The network 106 may be any type of network, such as the internet or another type of wide area network. In some cases, the network 106 may facilitate communication between the central server or computer system 102 and multiple client devices, represented by icons for a laptop 104-1, a desktop computer 104-2, and a smartphone 104-N. The use of “N”suggests there could be numerous devices connected.

In some aspects, the central server or computer system 102 may be configured to receive, process, and store holdings data from a portfolio manager. The processor(s) 108 may execute instructions stored in the memory 112 to perform various operations, such as transforming holdings data into episode data, identifying decisions from the episode data, determining the type of each decision, generating insights based on the identified decisions and their types, and generating nudges and a performance score for the portfolio manager based on the insights and decision scores.

The I/O interface(s) 110 may facilitate communication between the central server or computer system 102 and the client devices 104-1, 104-2, 104-N. For example, the I/O interface(s) 110 may receive holdings data from a portfolio manager via one of the client devices, and may transmit insights, nudges, and performance scores to the portfolio manager via one of the client devices.

In some cases, the memory 112 may store various types of data, such as holdings data, episode data, decision data, insight data, nudge data, and performance score data. The memory 112 may also store instructions for executing the various operations described above.

In some aspects, the client devices 104-1, 104-2, 104-N may be any type of computing device capable of communicating with the central server or computer system 102 via the network 106. For example, the client devices may include personal computers, laptops, tablets, smartphones, or any other type of device capable of transmitting and receiving data over a network. The client devices may be used by portfolio managers to interact with the system, such as by providing holdings data to the system and receiving insights, nudges, and performance scores from the system.

The present disclosure provides a system and method for processing holdings data of a portfolio manager. The system receives holdings data from a portfolio manager and transforms the holdings data into episode data. The holdings data may comprise time-series data corresponding to instruments owned by the portfolio manager at a certain time. Each episode comprises a series of decisions made by the portfolio manager, which are identified and categorized into decision types such as instrument picking, entry timing, sizing, scaling in, size adjusting, scaling out, and exit timing.

The system further enriches the episode data by adding market data, calculated metrics data, and island data. This enriched data is then used to generate insights based on the identified decisions, their types, and a decision score. These insights may include a ranking of the portfolio manager's decision-making performance relative to other portfolio managers, an analysis of the portfolio manager's decision-making skill across a number of different dimensions including position size, holding period, risk and market conditions, and recommendations for improving future decision-making.

The system also generates nudges and a performance score for the portfolio manager based on these insights. The nudges may be personalized based on the portfolio manager's historical decision-making patterns and may be provided as real-time alerts. The performance score may be calculated based on a weighted average of the decision scores and updated in real-time based on the portfolio manager's ongoing decisions

In some aspects, the system may also generate a visual representation of the decision type of the one or more decisions, the patterns of behavior exhibited by the portfolio manager in executing the one or more decisions, respective impacts of the decisions on the portfolio value measured in either absolute terms or relative to a benchmark. Further, the system may provide a historical analysis of the portfolio manager's decision-making patterns over a specified period, and perform a comparative analysis of the portfolio manager's decision-making skill relative to a peer group. In some aspects, the portfolio manager's decision making skill may be compared to the portfolio manager's historical performance.

The machine learning algorithms used in the system may be trained to detect instruments in the holdings data and to detect episodes for these instruments based on triggers such as buying decisions and selling decisions. The training dataset for these algorithms may comprise a plurality of portfolios, corresponding holdings data for these portfolios, labelled episodes for instruments in the corresponding holdings data, and labelled triggers for these episodes.

In this way, the system provides a comprehensive, data-driven approach to decision-making for investment, enabling portfolio managers to gain granular insights into their investment processes and optimize their investment strategies.

In some aspects, the system may process the holdings data into episode data, where the episode data comprises one or more episodes. Each episode from the one or more episodes may comprise a plurality of decisions made by the portfolio manager. These decisions may be identified and categorized into decision types such as instrument picking, entry timing, sizing, scaling in, size adjusting, scaling out, and exit timing.

In some cases, the episodes may be determined based on one or more parameters. These parameters may include, but are not limited to, an entry window, an exit window, a holding threshold, and a maximum scaling period. For example, the entry window may determine what constitutes the entry period of the episode in turn directly defining the entry timing decision and by extension all other decisions (scaling in, instrument picking, sizing, size adjusting). Similarly, an exit window may determine what constitutes the exit period of the episode. in turn directly defining the exit timing decision and by extension all other decisions (scaling out, instrument picking, sizing, size adjusting). A holding threshold parameter may define a minimum quantity of an instrument that must be held to consider it as part of an episode.

In other aspects, the system may use different parameters or combinations of parameters to determine the episodes. For instance, the system may use a combination of entry time and exit time parameters to determine the scaling in and scaling out decisions as part of the episode definition. The specific parameters used to determine the episodes may be selected based on the specific requirements or preferences of the portfolio manager, the characteristics of the portfolio, or other relevant factors.

In yet other aspects, the system may use machine learning algorithms to determine the episodes based on the holdings data and the parameters. The machine learning algorithms may be trained on historical holdings data and corresponding episodes to learn the patterns and relationships between the holdings data and the episodes. Once trained, the machine learning algorithms may be used to automatically determine the episodes from new holdings data, thereby facilitating the efficient and accurate processing of the holdings data into episode data.

In some aspects, the system may receive holdings data from the portfolio manager. This data may include, but is not limited to, the names of the instruments held by the portfolio manager, the quantities of each instrument held, the prices at which the instruments were bought or sold, and the dates of the transactions. The holdings data may be provided in various formats, such as spreadsheets, databases, or data feeds, and may be received through various channels, such as electronic mail, file transfer protocol, or application programming interfaces.

In some cases, the system may receive the holdings data directly from the portfolio manager or from a third-party data provider. The system may also receive the holdings data in real-time, near real-time, or at predetermined intervals, such as daily, weekly, or monthly. The frequency and timing of the data reception may be configured based on the specific requirements or preferences of the portfolio manager, the characteristics of the portfolio, or other relevant factors.

In other aspects, the system may preprocess the received holdings data before transforming it into episode data. The preprocessing may include, but is not limited to, data cleaning, data normalization, data integration, and data transformation. For example, the system may clean the data by removing or correcting erroneous or missing values, normalize the data by converting different data formats into a common format, integrate the data by combining data from different sources, and transform the data by converting raw data into a more suitable format for analysis.

In yet other aspects, the system may store the received holdings data in a data storage device for further processing or future reference. The data storage device may be a local storage device, such as a hard disk drive or a solid-state drive, or a remote storage device, such as a cloud storage service. The system may also use various data management techniques, such as data indexing, data partitioning, and data compression, to efficiently store and retrieve the holdings data.

In some aspects, the system may use a first machine learning algorithm to transform the holdings data into episode data. This transformation process may involve solving a ‘Gaps and islands’ problem, which refers to the identification and handling of gaps in the holdings data and the grouping of contiguous data into islands or episodes. The ‘Gaps and islands’ problem may have added complexity due to weekends, which are not considered trading days and thus are not included in the holdings data. The weekends may be included in the episode to maintain the continuous time series data. Further, the instrument quantities may change over the weekends due to one or more external factors. The system may incorporate the instrument quantity change over the weekend to maintain the standard holdings data flow. The first machine learning algorithm may be trained to recognize and handle this complexity, thereby ensuring the accurate transformation of the holdings data into episode data. The gaps correspond to empty data fields in the holdings data where the portfolio does not hold a minimum quantity of an instrument. In an aspect, the gaps may be used to identify the end of an episode.

In some cases, the first machine learning algorithm may also perform forward filling, which involves filling gaps in the holdings data in certain cases. For example, if there is a gap in the data due to a trading holiday, the algorithm may fill this gap with the data from the previous trading day. This forward filling process may help to maintain the continuity of the episode data and improve the accuracy of the subsequent decision identification and categorization processes.

In other aspects, the first machine learning algorithm may use various techniques and methods to solve the ‘Gaps and islands’ problem and perform forward filling. For instance, the algorithm may use time-series analysis techniques to identify gaps and islands in the holdings data, and interpolation methods to fill the gaps. The specific techniques and methods used by the algorithm may be selected based on the characteristics of the holdings data, the requirements of the episode transformation process, or other relevant factors.

In yet other aspects, the first machine learning algorithm may be trained on a training dataset comprising historical holdings data and corresponding episode data. The algorithm may learn the patterns and relationships between the holdings data and the episode data from this training dataset, and use this knowledge to transform new holdings data into episode data. The training dataset may be updated periodically or continuously with new holdings data and corresponding episode data, thereby enabling the algorithm to adapt to changes in the holdings data or the episode transformation process over time.

In some aspects, the first machine learning algorithm maybe retrained based on feedback comprising corrections corresponding to identified gaps and islands. The retrained machine learning algorithm may then be used to transform the holdings data into episode data more accurately based on past corrections.

In some aspects, the system may enrich the episode data by adding market data, calculated metrics data, and island data. The market data may include, but is not limited to, security prices, trading volumes, sector and industry classifications, fundamental company data, factor data, and ownership data. The calculated metrics data may comprise various metrics derived from the holdings data and the market data, such as, but not limited, to returns, volatilities, correlations, and measures of risk exposure and technical patterns. The island data may be determined based on specific criteria, such as the continuity of trading days and the presence of gaps due to weekends or trading holidays. The specific types of market data, calculated metrics, and island data added to the episode data may be selected based on the requirements of the decision identification and categorization processes, the characteristics of the portfolio, or other relevant factors.

In some cases, the system may perform post-processing on the enriched episode data to detect and adjust for corporate actions. Corporate actions may include, but are not limited to, instrument splits, dividends, mergers, and acquisitions. The system may detect these corporate actions based on changes in the market data, such as sudden changes in instrument prices or trading volumes, and make appropriate adjustments to the episode data. For example, in the case of an instrument split, the system may adjust the quantities of the instrument held in the episode data to reflect the split.

In other aspects, the system may convert all episodes into the base currency of the portfolio during the post-processing. This conversion may involve converting the prices, returns, and other monetary values in the episode data from their original currencies to the base currency. The conversion may be performed using exchange rates obtained from a reliable source, such as a financial data provider or a central bank. The conversion to the base currency may help to standardize the episode data and facilitate the comparison of decisions involving different instruments or markets.

In yet other aspects, the system may use different methods or techniques to enrich the episode data, detect and adjust for corporate actions, and convert the episodes into the base currency. For instance, the system may use statistical methods, machine learning algorithms, or other computational methods to perform these tasks. The specific methods or techniques used may be selected based on their suitability for the task, their performance in terms of accuracy and efficiency, or other relevant factors.

In some aspects, the system may use a second machine learning algorithm to identify one or more decisions made by the portfolio manager from the episode data. This identification process may involve looking up the price for every episode day and calculating specific metrics, such as the open price, close price, mark to market, prior market value, dividends, and trades. These calculated metrics may provide valuable information about the decisions made by the portfolio manager and may be used to categorize these decisions into decision types.

In some aspects, the system may transform the episode data into a relative episode data comprising relative episodes. The system may calculate an adjusted value of the price of the instrument in the portfolio based on the selected benchmark. The system may be configured to calculate the adjusted value based on a relativity factor and one or more mathematical functions. The relativity factor may be pre-defined. Further to calculating the relative episode data, the system may determine a portfolio manager's performance based on the relative episode data instead of the holdings data thereby, reducing processing time and cost.

In some cases, the second machine learning algorithm may redo the calculations using the relative price instead of the absolute price for relative episodes. The relative price may be a price relative to a benchmark or a reference price, and may provide a different perspective on the decisions made by the portfolio manager. For example, a decision to buy an instrument that subsequently rises but does not rise as much as the benchmark or reference price, may be analyzed favorably using absolute episodes as a result of the absolute price rise, while it may be analyzed unfavorably using relative episodes as a result of the relative price decline.

In other aspects, the second machine learning algorithm may use machine learning techniques to generate a set of features for each episode on each episode day during the categorization process. These features may include, but are not limited to, price trends, volume trends, volatility measures, and other derived metrics. The generated features may capture the characteristics of the decisions made by the portfolio manager and may be used to provide an analysis of the portfolio manager's decision-making skill, as well as recommendations for improving future decision-making.

In yet other aspects, the second machine learning algorithm may be trained on a training dataset comprising historical episode data and corresponding decision data. The algorithm may learn the patterns and relationships between the episode data and the decision data from this training dataset, and use this knowledge to identify and categorize decisions from new episode data. The training dataset may be updated periodically or continuously with new episode data and corresponding decision data, thereby enabling the algorithm to adapt to changes in the decision identification and categorization process over time.

In some aspects, the system may use different machine learning algorithms or techniques for the decision identification and categorization process. For instance, the system may use supervised learning algorithms and reinforcement learning algorithms, depending on the availability of labeled decision data, the complexity of the decision patterns, or other relevant factors. Reinforcement learning algorithms may be used to retrain the machine learning algorithms based on feedback.

In some aspects, the system may determine a decision type for each decision identified from the episode data. The decision type may be one of instrument picking, entry timing, sizing, scaling in, size adjusting, scaling out, and exit timing. For instance, an instrument picking decision may be detected when a new instrument appears in the portfolio holdings. The picking decision may continue until the instrument disappears from the portfolio. An entry timing decision may also be detected when a new instrument appears in the portfolio holdings, while an exit timing decision may be detected when the quantity held of the instrument goes to zero.

In some cases, a sizing decision may be detected by looking at the size of each position as a percentage of the total instruments in the portfolio and comparing that with a hypothetical version of the portfolio where all of the instruments were equally weighted. Any day when something other than an equally-weighted portfolio has been held may be defined as a sizing decision. A scaling in or scaling out decision may be detected when the quantity held of the instrument changes during the scaling period, which may be the period during which the portfolio manager gradually increases or decreases the quantity held of the instrument up to a predefined threshold, and which further may be curtailed by the detection of a change in instrument quantity in the countervailing direction. A size-adjusting decision may be detected when the quantity held changes during a “coasting” period, which may be a period beginning after the scaling in period has ended and ending at the beginning of the scaling out period, if it exists.

In other aspects, a given decision might have more than one decision type. For example, an increase in quantity held during the scaling in period might be considered both a scaling in decision and a sizing decision. The system may use rules or machine learning algorithms to define the decision types and determine which type a decision is and when it should be considered what type. These rules or algorithms may be based on various factors, such as the characteristics of the decision, the context of the decision within the episode, the historical decision-making patterns of the portfolio manager, or other relevant factors.

In yet other aspects, the decision types may be considered in reference to a baseline alternative. The baseline alternative may be a hypothetical scenario or strategy that serves as a reference for comparison. For example, the baseline alternative for an instrument picking decision may be a scenario where the portfolio manager made an equivalent investment in the reference benchmark instrument, while the baseline alternative for a sizing decision may be a scenario where the portfolio manager held an equally-weighted portfolio. The comparison with the baseline alternative may help to quantify the impact of the decision on the portfolio and provide a basis for the calculation of the decision score.

In some aspects, the system may calculate a decision score for each identified decision. The decision score may correspond to the impact of the decision on the portfolio managed by the portfolio manager. For instance, a decision that leads to a significant increase in the portfolio value may receive a high decision score, while a decision that results in a substantial decrease in the portfolio value may receive a low decision score. The decision score may provide a quantitative measure of the effectiveness or profitability of the decision, and may be used to evaluate the decision-making performance of the portfolio manager.

In some cases, the decision score may be calculated based on the time-weighted return on investment of an instrument over a period of the episode. The time-weighted return on investment may be a measure of the rate of return of the instrument, taking into account the timing and amount of cash flows associated with the instrument. The time-weighted return on investment may be calculated by dividing the change in the instrument value by the initial instrument value, and then multiplying the result by the duration of the episode. This calculation may provide a decision score that reflects the impact of the decision on the portfolio value over time, and may be particularly useful for decisions involving instruments with variable cash flows or irregular trading periods

In other aspects, the period of the episode may correspond to the difference between the exit day and the entry day. The entry day may be the day when the portfolio manager initiates a new position by buying or selling short a quantity of instruments. The exit day may be the day when the portfolio manager eliminates the position by selling or covering the last instrument held. The period of the episode may provide a measure of the duration of the decision, and may be used to normalize the decision score for comparison with other decisions or benchmarks.

In yet other aspects, the system may use different methods or formulas to calculate the decision score, depending on the characteristics of the decision, the requirements of the decision evaluation process, or other relevant factors. For instance, the system may use a money-weighted return on investment method for decisions involving instruments with constant cash flows or regular trading periods. The money-weighted return on investment may be calculated by dividing the net profit of the decision by the total investment, and then multiplying the result by the duration of the episode. This calculation may provide a decision score that reflects the impact of the decision on the portfolio value in monetary terms, and may be particularly useful for decisions involving large investments or high profits.

In some aspects, the system may generate insights based on the identified decisions, their types, and the decision scores. These insights may provide valuable information about the decision-making performance of the portfolio manager and may be used to guide future decision-making. For instance, the insights may reveal patterns or trends in the portfolio manager's decisions, such as a tendency to make certain types of decisions in certain market conditions or a preference for certain instruments or sectors, and the impact of those patterns or trends on portfolio performance. The insights may also identify strengths and weaknesses in the portfolio manager's decision-making, such as a high success rate in instrument picking decisions but a low success rate in timing decisions.

In some cases, the insights may include a ranking of the portfolio manager's decision-making performance relative to other portfolio managers. This ranking may be based on the decision scores, with higher scores indicating better performance. The ranking may provide a benchmark for the portfolio manager and may help to identify areas for improvement. The ranking may be calculated for each decision type separately, for a combination of decision types, or for all decision types together. The specific method used to calculate the ranking may depend on the requirements or preferences of the portfolio manager, the characteristics of the portfolio, or other relevant factors.

In other aspects, the system may generate insights in real-time, near real-time, or at predetermined intervals. The frequency and timing of the insight generation may be configured based on the specific requirements or preferences of the portfolio manager, the characteristics of the portfolio, or other relevant factors. For instance, the system may generate insights in real-time for high-frequency trading decisions. In other aspects, the insights may be generated after a predefined time period.

In yet other aspects, the system may present the insights in various formats, such as text reports, graphical charts, or interactive dashboards. The presentation format may be selected based on the specific requirements or preferences of the portfolio manager, the complexity of the insights, or other relevant factors. For example, the system may present the insights as a text report for a portfolio manager who prefers detailed written explanations, as a graphical chart for a portfolio manager who prefers visual representations, or as an interactive dashboard for a portfolio manager who prefers to explore the insights interactively.

In some aspects, the system may generate nudges for the portfolio manager based on the insights derived from the identified decisions, the decision type of the identified decisions, and the decision scores. These nudges may serve as prompts or reminders for the portfolio manager to consider certain factors, ask certain questions, or take certain actions in their decision-making process, in order to avoid costly mistakes. For instance, a nudge may prompt the portfolio manager to re-validate the investment hypothesis underlying an instrument that has been behaving in a way that has led to greater losses in the past, or it may prompt a portfolio manager who has historically destroyed value by scaling out of positions slowly to consider exiting completely when a trimming decision has been identified instrument

In some cases, the nudges may be personalized based on the portfolio manager's historical decision-making patterns using a machine learning algorithm to train an AI module for personalizing the nudges. The system may employ the AI module to analyze the portfolio manager's past decisions, the decision types, and the decision scores to identify patterns or trends in the portfolio manager's decision-making. These patterns or trends may then be used to tailor the nudges to the portfolio manager's specific needs, preferences, or habits. For example, a nudge may notify the portfolio manager when market conditions are or are not of the type that have been conducive to favorable decision-making by that portfolio manager in the past.

In other aspects, the nudges may be provided as real-time alerts to the portfolio manager. These alerts may be delivered through various channels, such as electronic mail, mobile notifications, or application programming interfaces, and may be formatted in various ways, such as text messages, graphical icons, or audible signals. The real-time delivery of the nudges may help to ensure that the portfolio manager receives the nudges at the right time, when they are most relevant and useful for the portfolio manager's decision-making process.

In yet other aspects, the system may use different methods or algorithms to generate the nudges, personalize them based on the portfolio manager's historical decision-making patterns, and deliver them as real-time or scheduled alerts. For instance, the system may use rule-based methods, or other computational methods to generate the nudges, data mining techniques, pattern recognition algorithms, or other analytical methods to personalize the nudges, and communication protocols, notification services, or other delivery methods to deliver the nudges. The specific methods or algorithms used may be selected based on their suitability for the task, their performance in terms of accuracy and efficiency, or other relevant factors.

In some aspects, the system may present a set of options comprising one or more actions for the portfolio manager to choose based on the nudge. The portfolio manager may select one or more options to perform the actions. In an aspect, the options may be presented to the portfolio manager on a display of a personal device including a computer, a smart phone, and the like. In another aspect, the options may be presented to the portfolio manager via a communication channel such as a text message, an email, and the like. The actions may comprise at least one of one or more decisions related to an instrument, pausing trades for the portfolio manager to prevent the portfolio manager from making wrong decisions, and the like. The system may implement the actions based on the options selected by the portfolio manager upon being nudged.

In some aspects, the system may calculate an overall performance score for the portfolio manager based on the decision scores. The performance score may provide a comprehensive measure of the portfolio manager's decision-making performance, taking into account all the decisions made by the portfolio manager and their respective impacts on the portfolio. The performance score may be used to evaluate the portfolio manager's overall decision-making performance, compare the portfolio manager's decision-making performance with that of other portfolio managers, or track the portfolio manager's decision-making performance over time.

In some cases, the performance score may be calculated as a weighted average of the decision scores. The weights may be determined based on various factors, such as the importance of the decision types, the frequency of the decisions, the volatility of the decision scores, or other relevant factors. For instance, decisions of types that have a greater impact on the portfolio value, such as instrument picking or sizing decisions, may be assigned higher weights, while decisions of types that have a lesser impact on the portfolio value, such as entry timing or exit timing decisions, may be assigned lower weights. The weighted average calculation may help to ensure that the performance score accurately reflects the portfolio manager's decision-making performance, taking into account the relative importance and variability of the different decision types.

In other aspects, the system may use different methods or formulas to calculate the decision-making performance score, depending on the characteristics of the decisions, the requirements of the performance evaluation process, or other relevant factors. For instance, the system may use a simple average, a geometric mean, a harmonic mean, or other types of averages to calculate the performance score. The specific method or formula used may be selected based on its suitability for the task, its performance in terms of accuracy and robustness, or other relevant criteria.

In yet other aspects, the system may update the performance score in real-time, near real-time, or at predetermined intervals, based on the portfolio manager's ongoing decisions. The real-time or near real-time updating of the performance score may help to provide timely feedback to the portfolio manager, enabling the portfolio manager to adjust their decision-making process as needed. The frequency and timing of the performance score updating may be configured based on the specific requirements or preferences of the portfolio manager, the characteristics of the portfolio, or other relevant factors.

In some aspects, the system may determine the decision types by comparing the actual decisions made by the portfolio manager with a baseline alternative. The baseline alternative may be a hypothetical scenario or strategy that serves as a reference for comparison. For example, the baseline alternative for an instrument picking decision may be a scenario where the portfolio manager made an equal investment in the reference benchmark instrument, while the baseline alternative for a sizing decision may be a scenario where the portfolio manager held an equally-weighted portfolio. The comparison with the baseline alternative may help to quantify the impact of the decision on the portfolio and provide a basis for the calculation of the decision score.

In some cases, the parameters used to determine the episodes and the decision types may be predefined. These parameters may include, but are not limited to, an entry window, an exit window, a holding threshold, and a maximum scaling period. For instance, an entry window parameter may define when a new instrument appears in the portfolio holdings, indicating an instrument picking or entry timing decision. Similarly, an exit window parameter may define the end of the episode instrument, indicating an exit timing decision. A holding threshold parameter may define a minimum quantity of an instrument that must be held to consider it as part of an episode, while a maximum scaling parameter may define the maximum duration for which an episode may be considered to be in a scaling in or scaling out period. instrument

[symbol]

In other aspects, the system may use different parameters or combinations of parameters to determine the episodes and the decision types. For example, the system may use a combination of entry window and exit window parameters to determine episodes for scaling in and scaling out decisions. The specific parameters used to determine the episodes and the decision types may be selected based on the specific requirements or preferences of the portfolio manager, the characteristics of the portfolio, or other relevant factors.

In some aspects, the insights generated by the system may include a comparative analysis of the portfolio manager's decision-making performance against a benchmark. The benchmark may be a market index, a peer group average or median, a target score, or any other standard of comparison that is relevant to the portfolio manager's investment strategy or objectives. The comparative analysis may involve using the decision performance score generated from the episodes produced by the system This comparison may provide a relative measure of the portfolio manager's decision-making performance, taking into account the performance of the market or the average performance of other portfolio managers.

In some cases, the system may calculate a benchmark-adjusted decision performance score for the portfolio manager. This score may be calculated by comparing the value of the portfolio for with the value of the benchmark. A positive benchmark-adjusted performance score may indicate that the portfolio manager has made value-adding decisions relative to the reference benchmark, while a negative benchmark-adjusted performance score may indicate that the portfolio manager has made value-destroying decisions relative to the benchmark. The benchmark-adjusted performance score may provide a more accurate measure of the portfolio manager's decision-making performance, as it takes into account the performance of the market or the average performance of other alternatives.

In other aspects, the system may use different methods or formulas to calculate the benchmark-adjusted performance score, depending on the characteristics of the benchmark, the requirements of the performance evaluation process, or other relevant factors. For instance, the system may use a risk-adjusted return method, a Sharpe ratio method, or other types of performance measurement methods to calculate the benchmark-adjusted performance score. The specific method or formula used may be selected based on its suitability for the task, its performance in terms of accuracy and robustness, or other relevant criteria.

In yet other aspects, the system may use an elicitation engine to present the comparative analysis and the benchmark-adjusted performance score in various formats, such as text reports, graphical charts, or interactive dashboards. The presentation format may be selected based on the specific requirements or preferences of the portfolio manager, the complexity of the analysis, or other relevant factors. For example, the system may present the insights as a text report for a portfolio manager who prefers detailed written explanations, as a graphical chart for a portfolio manager who prefers visual representations, or as an interactive dashboard for a portfolio manager who prefers to explore the insights interactively. In some aspects, the system may update the performance score in real-time based on the portfolio manager's ongoing decisions. This real-time updating may provide immediate feedback to the portfolio manager, enabling them to adjust their decision-making process as needed. For instance, if a recent decision results in a significant increase in the portfolio value, the performance score may be immediately updated to reflect this positive impact. Conversely, if a recent decision leads to a substantial decrease in the portfolio value, the performance score may be immediately updated to reflect this negative impact.

In some cases, the system may use various methods or algorithms to update the performance score in real-time. For instance, the system may use a sliding window method, where the performance score is recalculated over a recent window of decisions, or a decay method, where the impact of older decisions on the performance score gradually decreases over time. The specific method or algorithm used for real-time updating may be selected based on its suitability for the task, its performance in terms of accuracy and responsiveness, or other relevant factors.

In other aspects, the system may update the performance score at predetermined intervals, such as at the end of each trading day, week, or month, based on the portfolio manager's ongoing decisions. This periodic updating may provide a regular summary of the portfolio manager's decision-making performance, enabling them to review and reflect on their decisions over a certain period. The frequency and timing of the periodic updating may be configured based on the specific requirements or preferences of the portfolio manager, the characteristics of the portfolio, or other relevant factors.

In yet other aspects, the system may use different methods or algorithms to update the performance score at predetermined intervals. For instance, the system may use a batch processing method, where the performance score is recalculated over a batch of recent decisions, or a time-series analysis method, where the performance score is recalculated based on a time-series of decisions. The specific method or algorithm used for periodic updating may be selected based on its suitability for the task, its performance in terms of accuracy and comprehensiveness, or other relevant factors.

In some aspects, the insights generated by the system may include an analysis of the portfolio manager's decision-making skill in different market conditions. This analysis may involve comparing the decision scores of the portfolio manager in different market conditions, such as bull markets, bear markets, volatile markets, or stable markets. The comparison may reveal patterns or trends in the portfolio manager's decision-making performance, such as a tendency to perform better in bull markets or a tendency to perform worse in volatile markets. This analysis may provide valuable information for the portfolio manager, enabling them to adjust their decision-making strategy based on the current or expected market conditions.

In some cases, the system may use various methods or algorithms to analyze the portfolio manager's decision-making skill in different market conditions. For instance, the system may use statistical methods, machine learning algorithms, or other computational methods to identify the different market conditions, calculate the decision scores in each market condition, and compare the decision scores across different market conditions. The specific methods or algorithms used may be selected based on their suitability for the task, their performance in terms of accuracy and robustness, or other relevant factors

In other aspects, the system may use different criteria or indicators to define the different market conditions. For example, the system may use price trends, volatility measures, economic indicators, or other market data to define bull markets, bear markets, volatile markets, and stable markets. The specific criteria or indicators used may be selected based on their relevance to the portfolio manager's investment strategy, their reliability in predicting market conditions, or other relevant factors.

In yet other aspects, the system may present the analysis of the portfolio manager's decision-making skill in different market conditions in various formats, such as text reports, graphical charts, or interactive dashboards. The presentation format may be selected based on the specific requirements or preferences of the portfolio manager, the complexity of the analysis, or other relevant factors. For example, the system may present the analysis as a bar chart showing the decision scores of the portfolio manager in different market conditions, or as a heat map showing the decision scores of the portfolio manager in different market conditions and for different decision types.

In some aspects, the insights generated by the system may include recommendations for improving future decision-making by the portfolio manager. These recommendations may be derived from the analysis of the identified decisions, their types, and the decision scores. For instance, if the system detects a pattern of low decision scores for sizing decisions, it may recommend the portfolio manager to review their sizing strategy or to seek additional training in this area. Similarly, if the system detects a pattern of high decision scores for instrument picking decisions in certain market conditions, it may recommend the portfolio manager to focus more on these market conditions in their instrument picking strategy.

In some cases, the recommendations may be personalized based on the portfolio manager's historical decision-making patterns. The system may analyze the portfolio manager's past decisions, their types, and their scores to identify patterns or trends in the portfolio manager's decision-making. These patterns or trends may then be used to tailor the recommendations to the portfolio manager's specific needs, preferences, or habits. For example, if the system detects a pattern of successful instrument picking decisions followed by unsuccessful timing decisions, it may recommend the portfolio manager to focus more on their timing decisions. In another example, the system may recommend a portfolio manager to hold back on making decisions when a pattern that matches a historic streak of negative or losing decisions.

In other aspects, the system may use different methods or algorithms to generate the recommendations. For instance, the system may use rule-based methods, machine learning algorithms, Natural Language Processing, Natural Language Understanding, or other computational methods to generate the recommendations. The specific methods or algorithms used may be selected based on their suitability for the task, their performance in terms of accuracy and efficiency, or other relevant factors.

In yet other aspects, the system may present the recommendations in various formats, such as text reports, graphical charts, or interactive dashboards. The presentation format may be selected based on the specific requirements or preferences of the portfolio manager, the complexity of the recommendations, or other relevant factors. For example, the system may present the recommendations as a text report for a portfolio manager who prefers detailed written explanations, as a graphical chart for a portfolio manager who prefers visual representations, or as an interactive dashboard for a portfolio manager who prefers to explore the recommendations interactively.

In some aspects, the system may calculate the Threshold and Entry/Exit Window for each episode. The threshold for scaling period may be defined as the maximum length of the scaling period, which is the period during which the portfolio manager gradually increases or decreases the quantity held of an instrument. The Entry/Exit Window may be defined as the period during which the portfolio manager initiates or concludes a decision, such as adding a new instrument to the portfolio or removing an instrument from the portfolio. The calculation of the threshold and Entry/Exit Window may be based on various factors, such as the characteristics of the instrument, the liquidity of the market, the historical decision-making patterns of the portfolio manager, or other relevant factors.

In some cases, the system may use machine learning algorithms to calculate the threshold and Entry/Exit Window. These algorithms may be trained on historical data, such as the portfolio manager's past decisions and the market data, to learn the patterns and relationships between the decisions and the threshold and Entry/Exit Window. Once trained, the algorithms may be used to automatically calculate the threshold and Entry/Exit Window for new episodes, thereby facilitating the efficient and accurate processing of the episode data.

In other aspects, the system may allow the portfolio manager to consolidate multiple days of trading together into the “entry” or “exit”. This consolidation may be useful in situations where the portfolio manager wants to consider a series of trades over several days as a single decision, rather than as separate decisions on each day. The system may provide a setting for the portfolio manager to specify the number of days to be consolidated, and may use this setting in the calculation of the Threshold and Entry/Exit Window.

In yet other aspects, the system may use different methods or algorithms to calculate the Threshold and Entry/Exit Window, and to consolidate multiple days of trading together into the “entry” or “exit”. For instance, the system may use statistical methods, optimization algorithms, or other computational methods to perform these tasks. The specific methods or algorithms used may be selected based on their suitability for the task, their performance in terms of accuracy and efficiency, or other relevant factors.

In some aspects, the system may generate real-time alerts, or nudges, for the portfolio manager based on the insights derived from the identified decisions, their types, and the decision scores. These nudges may serve as prompts or reminders for the portfolio manager to consider certain factors, take certain actions, or avoid certain mistakes in their decision-making process. The nudges may be personalized based on the portfolio manager's historical decision-making patterns and may be provided as real-time or scheduled alerts. The real-time or scheduled delivery of the nudges may help to ensure that the portfolio manager receives the nudges at the right time, when they are most relevant and useful for the portfolio manager's decision-making process.

In some aspects, the system may perform a comparative analysis of the portfolio manager's performance against one or more benchmarks. The system may select the benchmarks based on various factors, such as the investment strategy of the portfolio manager, the characteristics of the portfolio, the market conditions, or other relevant factors. For instance, the benchmarks may include market indices, peer group averages, target returns, or other standards of comparison. The comparative analysis may involve comparing the decision scores, the performance score, or other performance metrics of the portfolio manager with the performance of the benchmarks over the same period.

In some aspects, the benchmarks may be selected using a machine learning algorithm. The machine learning algorithm may be trained using historical performance data of one or more portfolio managers, selected benchmarks for calculation of the performance score of the portfolio managers, feedback including accepted benchmarks and rejected benchmarks, and improvement in performance of the portfolio managers. In an aspect, the system may generate a profile for the portfolio managers based on historical decisions made by the portfolio managers. Further, the system may find similar portfolio managers in order to analyze the historic performance data of the portfolio managers to select the benchmarks.

In yet other aspects, the system may update the comparative analysis and the visual representation in real-time, near real-time, or at predetermined intervals, based on the portfolio manager's ongoing decisions and the latest market data. The real-time or near real-time updating may provide timely feedback to the portfolio manager, enabling them to adjust their decision-making process as needed. The frequency and timing of the updating may be configured based on the specific requirements or preferences of the portfolio manager, the characteristics of the portfolio, or other relevant factors.

In some aspects, the system may generate a visual representation of the decision types and their respective impacts on the portfolio value. This visual representation may provide a clear and intuitive view of the portfolio manager's decision-making performance, highlighting the areas where the portfolio manager has added value or detracted value from the portfolio. The visual representation may be presented in various formats, such as bar charts, line charts, scatter plots, or heat maps, depending on the specific requirements or preferences of the portfolio manager, the complexity of the decision types, or other relevant factors.

In some cases, the visual representation may include a time-series chart showing the portfolio value over time, with different colors or symbols indicating the different decision types. This chart may help the portfolio manager to understand how their decisions have affected the portfolio value over time and to identify patterns or trends in their decision-making performance. The chart may also include markers or annotations indicating significant events or decisions, such as large trades, corporate actions, or market events, which may provide additional context for the portfolio manager's decisions.

In other aspects, the system may generate a matrix or table showing the decision scores for each decision type and each episode. This matrix or table may provide a detailed breakdown of the portfolio manager's decision-making performance, allowing the portfolio manager to compare their performance across different decision types and episodes. The matrix or table may also include summary statistics, such as the average, median, or standard deviation of the decision scores, which may provide additional insights into the portfolio manager's decision-making performance.

In yet other aspects, the system may generate a histogram or distribution chart showing the frequency of different decision scores for each decision type. This chart may help the portfolio manager to understand the distribution of their decision scores and to identify outliers or anomalies in their decision-making performance. The chart may also include reference lines or bands indicating the average or range of decision scores, which may provide a benchmark for the portfolio manager's performance.

In some aspects, the system may provide a historical analysis of the portfolio manager's decision-making patterns over a specified period. This analysis may involve comparing the decision scores, the decision types, or other performance metrics of the portfolio manager over different periods, such as daily, weekly, monthly, or yearly periods. The historical analysis may reveal patterns or trends in the portfolio manager's decision-making performance, such as a tendency to perform better in certain periods or a tendency to make certain types of decisions more frequently in certain periods. The historical analysis may be presented in various formats, such as time-series charts, trend lines, or heat maps, depending on the specific requirements or preferences of the portfolio manager, the complexity of the decision-making patterns, or other relevant factors.

In some aspects, the system may use machine learning algorithms to adjust assumptions around the Threshold and Entry/Exit Window based on the portfolio manager's historical data and market data. The Threshold may be defined as the maximum length of the scaling period, which is the period during which the portfolio manager gradually increases or decreases the quantity held of an instrument. The Entry/Exit Window may be defined as the period during which the portfolio manager initiates or concludes a decision, such as adding a new instrument to the portfolio or removing an instrument from the portfolio. The machine learning algorithms may be trained on historical data, such as the portfolio manager's past decisions and the market data, to learn the patterns and relationships between the decisions and the Threshold and Entry/Exit Window. Once trained, the algorithms may be used to automatically adjust the Threshold and Entry/Exit Window for new episodes, thereby facilitating the efficient and accurate processing of the episode data.

In some cases, the system may use reinforcement learning algorithms to learn where to fill, extend, or trim episodes based on human tagging. The reinforcement learning algorithms may be trained on a training dataset comprising historical episode data and corresponding human tags, which indicate where to fill, extend, or trim the episodes. The reinforcement learning algorithms may learn the patterns and relationships between the episode data and the human tags from this training dataset, and use this knowledge to automatically fill, extend, or trim new episodes, thereby improving the accuracy and efficiency of the episode generation process.

In other aspects, the system may detect fund flow trades based on what has been normal for the portfolio in the past. Fund flow trades may refer to changes in holding quantity that have been driven by the addition or subtraction of funds to/from the portfolio, rather than by a specific decision made by the portfolio manager to change the quantity held of a particular instrument. The system may use machine learning algorithms to detect these fund flow trades, by noticing days when an abnormally large number of instruments have been traded in a given portfolio.

In yet other aspects, the system may detect similarities between decisions with reference to market and/or fundamental context. The system may use machine learning algorithms to analyze the market data and the fundamental data, such as financial statements, economic indicators, news events, to identify patterns or similarities between different decisions. These similarities may provide valuable insights into the portfolio manager's decision-making strategy and may be used to generate recommendations for improving future decision-making.

In some aspects, the first machine learning algorithm may be trained to detect one or more instruments in the holdings data. The training process may involve feeding the algorithm with a training dataset that includes historical holdings data, which may comprise a plurality of portfolios, corresponding holdings data for these portfolios, labelled episodes for one or more instruments in the corresponding holdings data, and labelled triggers for these episodes. The algorithm may learn to recognize patterns and relationships in the holdings data that indicate the presence of specific instruments.

In some cases, the first machine learning algorithm may also be trained to detect episodes for the one or more instruments based on one or more triggers. These triggers may comprise at least one of a buying decision, a selling decision, and a shorting decision. For instance, a buying decision may be triggered when a new instrument appears in the portfolio holdings, a selling decision may be triggered when the quantity held of an instrument goes to zero, and a shorting decision may be triggered when the quantity held of an instrument becomes negative. The algorithm may learn to recognize these triggers in the holdings data and use them to detect the start and end of episodes for each instrument.

In other aspects, the training dataset used to train the first machine learning algorithm may comprise specific data types. These data types may include, but are not limited to, the names of the instruments held by the portfolio manager, the quantities of each instrument held, the prices at which the instruments were bought or sold, and the dates of the transactions. The training dataset may also include labelled episodes for one or more instruments in the corresponding holdings data, and labelled triggers for these episodes. The labelled episodes and triggers may provide the algorithm with examples of correct episode detection and trigger detection, which the algorithm can learn from and apply to new holdings data.

In yet other aspects, the training process for the first machine learning algorithm may involve various machine learning techniques, such as supervised learning, unsupervised learning, semi-supervised learning, or reinforcement learning. The specific techniques used may depend on the characteristics of the training dataset, the complexity of the episode detection and trigger detection tasks, or other relevant factors. For instance, supervised learning techniques may be used when the training dataset includes labelled episodes and triggers, while unsupervised learning techniques may be used when the training dataset does not include labels.

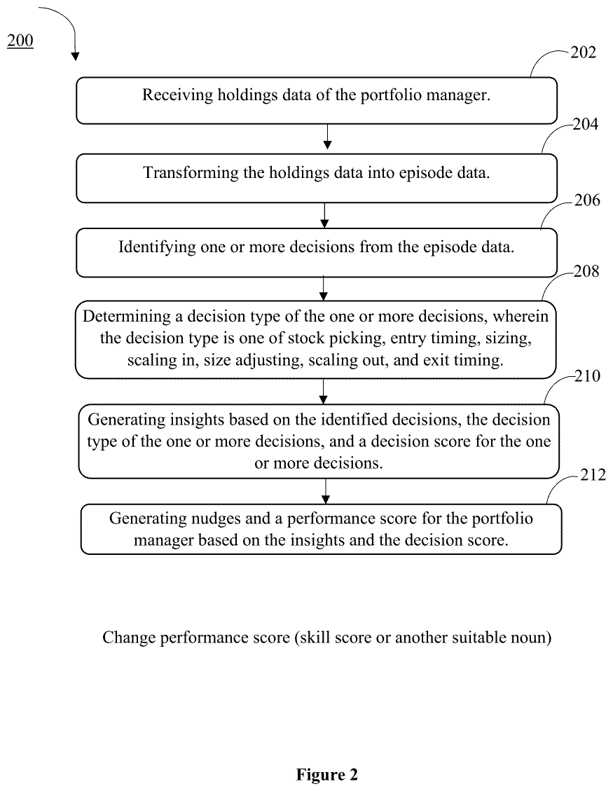

Referring to FIG. 2, a flowchart of the method for processing holdings data of a portfolio manager is depicted.

At 202, the method may begin with receiving holdings data of the portfolio manager. In some cases, the holdings data may be received from a portfolio manager via a network, such as the internet or another type of wide area network. The holdings data may include information about the portfolio manager's investment decisions, such as the instruments held in the portfolio, the quantity of each instrument held, the dates of purchase and sale of each instrument, and other relevant information.

The method may then, at 204, involve transforming the holdings data into episode data. In some aspects, this transformation may be performed using a first machine learning algorithm. The episode data may include one or more episodes, each of which may represent a period of time during which the portfolio manager held a particular instrument. Each episode may include a series of decisions made by the portfolio manager, such as decisions to buy or sell the instrument, decisions to increase or decrease the quantity of the instrument held, and other types of decisions.

Next, the method may involve, at 206, identifying one or more decisions made by the portfolio manager from the episode data. This identification may be performed using a second machine learning algorithm. The decisions may be identified based on changes in the holdings data, such as changes in the quantity of an instrument held, changes in the price of an instrument, and other changes that may indicate a decision made by the portfolio manager.

The method may then involve, at 208, determining the decision type of each identified decision. The decision type may be one of instrument picking, entry timing, sizing, scaling in, size adjusting, scaling out, and exit timing. In some cases, the decision type may be determined based on the nature of the decision, the context of the decision within the episode, and other factors.

The method may then involve, at 210, generating insights based on the identified decisions, their types, and a decision score associated with each decision. The insights may provide valuable information about the portfolio manager's decision-making process and its impact on portfolio performance. The insights may include, for example, an analysis of the portfolio manager's decision-making skill in different market conditions, a ranking of the portfolio manager's decision-making performance relative to other portfolio managers, and recommendations for improving future decision-making.

Finally, the method may involve, at 212, generating nudges and a performance score for the portfolio manager based on the insights and decision scores. The nudges may be personalized based on the portfolio manager's historical decision-making patterns and may provide real-time feedback to the portfolio manager. The performance score may be a measure of the portfolio manager's overall decision-making performance, and may be updated in real-time based on the portfolio manager's ongoing decisions.

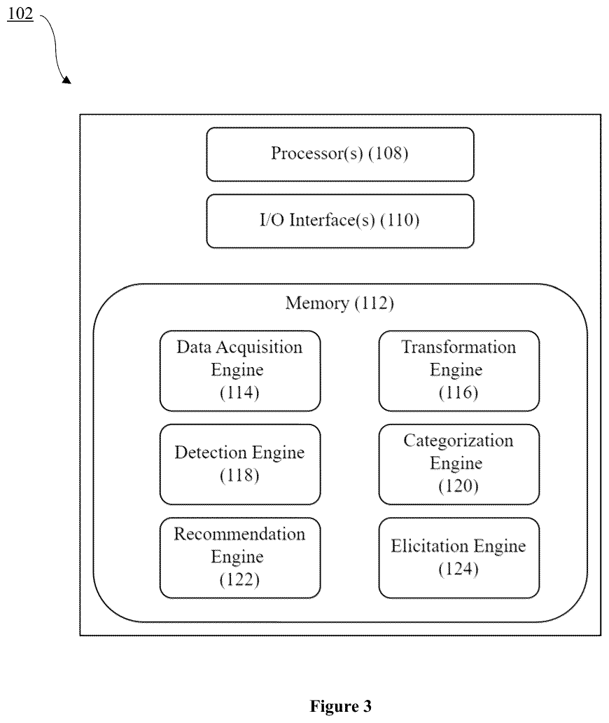

Referring to FIG. 3, an exemplary system architecture for processing holdings data of a portfolio manager is depicted. The system, numbered 102, may include a processor 108 and memory 112. The processor 108 may be configured to execute instructions stored in the memory 112 to perform various operations related to processing holdings data of a portfolio manager. These operations may include, but are not limited to, transforming holdings data into episode data, identifying decisions from the episode data, determining the type of each decision, generating insights based on the identified decisions and their types, and generating nudges and a performance score for the portfolio manager based on the insights and decision scores.

The memory 112 may store various types of data, such as holdings data, episode data, decision data, insight data, nudge data, and performance score data. In some cases, the memory 112 may also store instructions for executing the various operations described above. These instructions may be executed by the processor 108 to perform the operations.

Within the memory 112, there may be several engines configured to perform specific tasks related to processing holdings data of a portfolio manager. These engines may include a Data Acquisition Engine 114, a Transformation Engine 116, a Detection Engine 118, a Categorization Engine 120, a Recommendation Engine 122, and an Elicitation Engine 124.

The Data Acquisition Engine 114 may be configured to receive daily holdings data of the portfolio manager. This data may be received from a variety of sources, such as a portfolio management system, a trading platform, or other sources of holdings data.

The Transformation Engine 116 may be configured to transform the daily holdings data into episode data using a first machine learning algorithm. This transformation may involve processing the holdings data to identify episodes, which may represent periods of time during which the portfolio manager held a particular instrument.

The Detection Engine 118 may be configured to identify one or more decisions made by the portfolio manager from the episode data based on a second machine learning algorithm. The decisions may be identified based on changes in the holdings data, such as changes in the quantity of an instrument held, changes in the price of an instrument, and other changes that may indicate a decision made by the portfolio manager.

The Categorization Engine 120 may be configured to determine a decision type of each decision. The decision type may be one of instrument picking, entry timing, sizing, scaling in, size adjusting, scaling out, and exit timing. In some cases, the decision type may be determined based on the nature of the decision, the context of the decision within the episode, and other factors.

The Recommendation Engine 122 may be configured to generate insights based on the identified decisions, their types, and a decision score. The insights may provide valuable information about the portfolio manager's decision-making process and its impact on portfolio performance. The insights may include, for example, an analysis of the portfolio manager's decision-making skill in different market conditions, a ranking of the portfolio manager's decision-making performance relative to other portfolio managers, and recommendations for improving future decision-making.

The Elicitation Engine 124 may be configured to generate nudges and a performance score for the portfolio manager based on the insights. The nudges may be personalized based on the portfolio manager's historical decision-making patterns and may provide real-time feedback to the portfolio manager. The performance score may be a measure of the portfolio manager's overall decision-making performance, and may be updated in real-time based on the portfolio manager's ongoing decisions. The elicitation engine may generate nudges based on historical performance data of the portfolio managers by analyzing the improvement in the performance of a portfolio manager after nudged. The elicitation engine may modify the nudges based on the improvement in the performance.

In some aspects, the system 102 may also include one or more I/O interfaces 110. The I/O interfaces 110 may facilitate communication between the system 102 and external devices or systems. For example, the I/O interfaces 110 may receive holdings data from a portfolio manager via a network, and may transmit insights, nudges, and performance scores to the portfolio manager via the network.

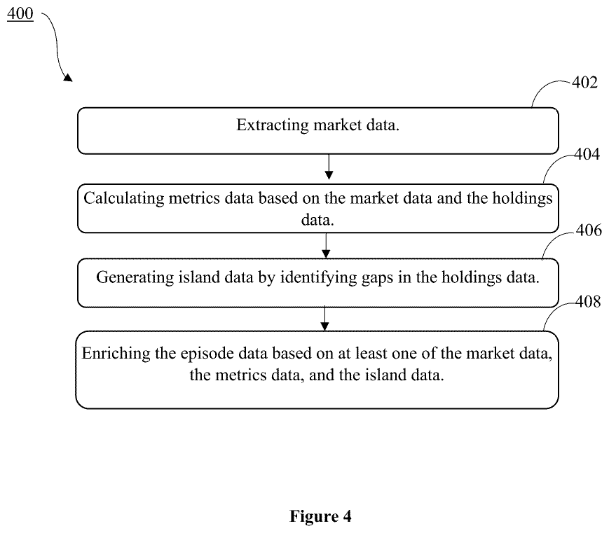

Referring to FIG. 4, a flowchart of a process for transforming and enriching episode data is depicted. The process may begin, at 402, with extracting market data. In some cases, the market data may include prices, benchmarks, and other relevant information. The market data may be extracted from a variety of sources, such as financial databases, trading platforms, or other sources of market data.

Next, the process may involve, at 404, calculating metrics data based on the market data and the holdings data. The metrics data may include derived metrics that are calculated based on the holdings data and the market data. For example, the metrics data may include the return on investment of each instrument in the portfolio, the volatility of each instrument, the correlation between different instruments, and other metrics that may be relevant to the portfolio manager's decision-making process.

The process may then involve, at 406, generating island data by identifying gaps in the episode data. The island data may represent periods of time during which the portfolio manager did not hold a particular instrument. These gaps may be identified based on the holdings data and a machine learning algorithm. For example, the machine learning algorithm may be trained to detect gaps in the holdings data that correspond to periods of time during which the portfolio manager did not hold a particular instrument.

Finally, the process may involve, at 408, enriching the episode data based on at least one of the market data, the metrics data, and the island data. The episode data may be enriched by adding the market data, the metrics data, and the island data to the episode data. This enrichment may provide additional context for the decisions made by the portfolio manager, potentially aiding in the identification of decisions and the determination of decision types.

In some aspects, the process of transforming and enriching episode data may be performed using a machine learning algorithm. The machine learning algorithm may be trained on a variety of data, including historical holdings data, market data, metrics data, and island data. This approach may allow the process to adapt to changing market conditions and evolving investment strategies, providing robust and flexible support for the transformation and enrichment of episode data.

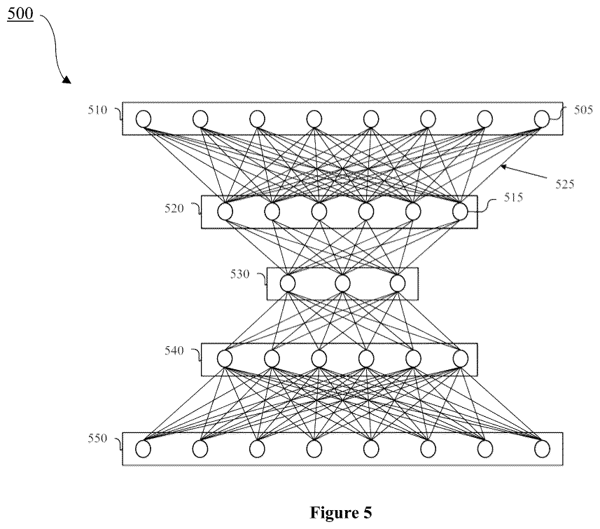

Referring to FIG. 5, a neural network architecture is depicted, which may be associated with the machine learning algorithms used for processing portfolio data and generating insights. The neural network may include multiple layers of interconnected nodes, with each node representing a neuron or a decision unit. The neural network may be trained using a variety of data, including historical holdings data, market data, and other relevant information. This training may allow the neural network to learn patterns in the data and make predictions or decisions based on these patterns.

In some aspects, the neural network may be used to generate a set of features for each episode on each episode day. These features may include, for example, the price of the instrument, the quantity of the instrument held, the volatility of the instrument, the correlation between different instruments, and other features that may be relevant to the portfolio manager's decision-making process. The features may be used as inputs to the neural network, which may output a decision or a prediction based on these inputs.

In some cases, the neural network may be used to adjust assumptions around the Threshold and Entry/Exit Window based on the investor's historical data and market liquidity. The Threshold may represent the maximum length of the scaling period, and the Entry/Exit Window may represent the time period during which the portfolio manager may enter or exit a position. The neural network may be trained to predict the optimal Threshold and Entry/Exit Window based on the investor's historical data and market liquidity, potentially improving the accuracy of these predictions and enhancing portfolio performance.

In some aspects, a reinforcement learning model may be used to learn where to fill, extend, or trim episodes based on human tagging. The reinforcement learning model may be a type of machine learning algorithm that learns by interacting with its environment and receiving feedback in the form of rewards or penalties. In this case, the environment may be the episode data, and the feedback may be the human tagging. The reinforcement learning model may be trained to fill, extend, or trim episodes in a way that maximizes a reward function or minimizes a penalty function, potentially improving the accuracy of these operations and enhancing portfolio performance.

In some cases, the neural network may be used to detect ‘not relevant’ decisions, which may be changes in holding quantity that have been driven by the addition or subtraction of funds to/from the portfolio, rather than by a specific decision made by the fund manager to change the quantity held of that particular instrument. The neural network may be trained to detect these ‘not relevant’ decisions based on a variety of data, including historical holdings data, fund flow data, and other relevant information. This approach may allow the neural network to accurately distinguish between ‘real’ decisions and ‘not relevant’ decisions, potentially improving the accuracy of the decision identification process and enhancing portfolio performance.

FIG. 5 illustrates an example artificial neural network (“ANN”) 500 of the machine learning algorithms and models described above. In particular embodiments, an ANN may refer to a computational model comprising one or more nodes. Example ANN 500 may comprise an input layer 510, hidden layers 520, 530, 540, and an output layer 550. Each layer of the ANN 500 may comprise one or more nodes, such as a node 505 or a node 515. In particular embodiments, each node of an ANN may be connected to another node of the ANN. As an example, and not by way of limitation, each node of the input layer 510 may be connected to one of more nodes of the hidden layer 520. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 5 depicts a particular ANN with a particular number of layers, a particular number of nodes, and particular connections between nodes, this disclosure contemplates any suitable ANN with any suitable number of layers, any suitable number of nodes, and any suitable connections between nodes. As an example, and not by way of limitation, although FIG. 5 depicts a connection between each node of the input layer 510 and each node of the hidden layer 520, one or more nodes of the input layer 510 may not be connected to one or more nodes of the hidden layer 520.

In particular embodiments, an ANN may be a feedforward ANN (e.g., an ANN with no cycles or loops where communication between nodes flows in one direction beginning with the input layer and proceeding to successive layers). As an example, and not by way of limitation, the input to each node of the hidden layer 520 may comprise the output of one or more nodes of the input layer 510. As another example and not by way of limitation, the input to each node of the output layer 550 may comprise the output of one or more nodes of the hidden layer 540. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example, and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example, and not by way of limitation, an activation function may be an identity function, a binary step function, a logistic function, or any other suitable function.

In particular embodiments, the input of an activation function corresponding to a node may be weighted. Each node may generate output using a corresponding activation function based on weighted inputs. In particular embodiments, each connection between nodes may be associated with a weight. As an example, and not by way of limitation, a connection 525 between the node 505 and the node 515 may have a weighting coefficient of 0.4, which may indicate that 0.4 multiplied by the output of the node 505 is used as an input to the node 515. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, the ANN may be trained using training data. As an example, and not by way of limitation, training data may comprise inputs to the ANN 500 and an expected output. As another example and not by way of limitation, training data may comprise vectors each representing a training object and an expected label for each training object. In particular embodiments, training the ANN may comprise modifying the weights associated with the connections between nodes of the ANN by optimizing an objective function. As an example, and not by way of limitation, a training method may be used (e.g., the conjugate gradient method, the gradient descent method, the stochastic gradient descent) to backpropagate the sum-of-squares error measured as a distance between each vector representing a training object (e.g., using a cost function that minimizes the sum-of-squares error). In particular embodiments, the ANN may be trained using a dropout technique. As an example, and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training the ANN in a particular manner, this disclosure contemplates training the ANN in any suitable manner.

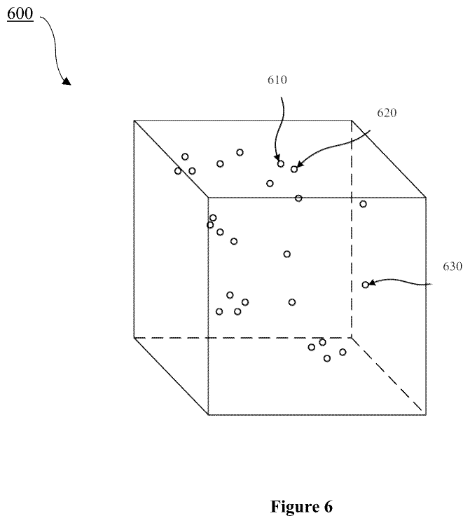

Referring to FIG. 6, a three-dimensional representation of decision data is depicted. This representation may visualize portfolio manager decisions and their impacts in a multi-dimensional space. The three-dimensional space, represented as a cube structure 600, may be defined by three axes, each representing a different parameter or dimension used in analyzing portfolio manager decisions. These parameters or dimensions may include, for example, the type of decision, the impact of the decision on portfolio value, and the timing of the decision.

In some aspects, each point within the cube structure 600 may represent a vector (610, 620, and 630) of one or more decisions made by the portfolio manager. The position of each point within the cube structure 600 may be determined based on the values of the parameters or dimensions for that decision. For example, a point located near the top front edge of the cube structure 600, represented as point 610, may represent a decision that had a high impact on portfolio value, was made early in the time period covered by the data, and corresponds to a particular decision type.

In some cases, the three-dimensional representation of decision data may provide a visual way to explore and understand the relationships between different decisions and their impacts on portfolio value. For example, the portfolio manager or other users may be able to visually identify clusters of decisions that had similar impacts on portfolio value, were made at similar times, or correspond to the same decision type. This visual representation may aid in the analysis of portfolio manager decisions and may provide insights that could be used to improve future decision-making.

In some aspects, the three-dimensional representation of decision data may be generated using a machine learning algorithm. The machine learning algorithm may be trained on a variety of data, including historical holdings data, decision data, and other relevant information. This approach may allow the machine learning algorithm to accurately position each decision within the cube structure 600 based on the values of the parameters or dimensions for that decision.

In some cases, the three-dimensional representation of decision data may be interactive, allowing the portfolio manager or other users to rotate the cube structure 600, zoom in or out, select individual points to view more detailed information about the corresponding decisions, or perform other interactive operations. This interactivity may enhance the usability of the three-dimensional representation and may provide a more engaging and informative way to explore and understand portfolio manager decisions and their impacts.

In some aspects, the system and method may involve a post-processing phase after the transformation of holdings data into episode data. During this post-processing phase, the system may detect and adjust for corporate actions. Corporate actions may include events initiated by a company that affect the securities issued by the company, such as instrument splits, dividends, mergers and acquisitions, rights issues, and others. The system may be configured to detect these corporate actions based on the holdings data and market data, and may adjust the episode data accordingly. For example, if an instrument split occurs during an episode, the system may adjust the quantity of the instrument held in the episode data to reflect the instrument split.

In some cases, the system may convert all episodes into the base currency of the portfolio. This conversion may be performed using exchange rate data, which may be part of the market data. The system may be configured to look up the exchange rate for each instrument in the portfolio on each episode day, and may convert the value of the instrument into the base currency using this exchange rate. This conversion may allow for a consistent comparison of the value of different instruments in the portfolio, regardless of the currency in which they are denominated.

In some aspects, the system may calculate the profit and loss (P&L) for each episode day. This calculation may be performed using various metrics, such as the open price, close price, mark to market, prior market value, dividends, and trades. The system may be configured to look up these metrics for each instrument in the portfolio on each episode day, and may calculate the P&L based on these metrics. The calculated P&L may provide a measure of the financial performance of the portfolio on each episode day, and may be used in the generation of insights and decision scores.

In some cases, the system may determine parameters for episodes, such as the Threshold and Entry/Exit Window. The Threshold may represent the maximum length of the scaling period, which may be the period during which the portfolio manager gradually enters or exits a position. The Entry/Exit Window may represent the time period during which the portfolio manager may enter or exit a position. The system may be configured to calculate these parameters based on the holdings data, market data, and other relevant information. For example, the system may calculate the Threshold based on the historical trading volume of each instrument in the portfolio, and may calculate the Entry/Exit Window based on the historical price volatility of each instrument. These calculated parameters may provide a framework for the identification of decisions and the determination of decision types.

Exemplary embodiments discussed above may provide certain advantages. Though not required to practice aspects of the disclosure, these advantages may include those provided by the following features.

Some embodiments of the system and the method may help in more efficient portfolio analysis due to better data handling.

Some embodiments of the system and the method provides accurate decision analysis of a portfolio manager.

Although implementations for methods and system for processing holdings data of a portfolio manager have been described in language specific to structural features and/or methods, it is to be understood that the appended claims are not necessarily limited to the specific features or methods described. Rather, the specific features and methods are disclosed as examples of implementations for processing holdings data of a portfolio manager.

A number of implementations have been described. Nevertheless, it will be understood that various modifications may be made without departing from the spirit and scope of the disclosure. Accordingly, other implementations are within the scope of the following claims.

1. A computer-implemented method for accurate transformation of time-series holdings data, comprising:
receiving, by a processor, holdings data comprising time-series data corresponding to one or more instruments;
generating, by a first machine learning algorithm, episode data from the holdings data, wherein the episode data is generated based on island data, wherein the island data comprises a beginning of an episode, an end of an episode, and an identified gap, wherein the gap corresponds to missing data points due to non-trading periods;
maintaining continuity of the episode data by forward filling the gap with data from a previous trading day, wherein the first machine learning algorithm is trained on a training dataset comprising historical holdings data, labeled episodes for instruments in the holdings data, and labeled triggers for the episodes;
enriching, by the processor, the episode data by adding at least one of market data, calculated metrics data, and island data;
standardizing the episode data based on a base currency of the portfolio, wherein the standardizing involves converting at least one of prices, returns, and monetary values in the enriched episode data from their original currencies to the base currency, and wherein the standardization comprises obtaining exchange rates from a data source including a financial data provider and a central bank;
transforming, by the processor, a first sub-set of the standardized episode data into relative episode data comprising relative episodes by calculating an adjusted value of a price of an instrument based on a selected benchmark, and determining a first performance score based on the relative episode data;
generating, by a neural network, a set of features for each episode from a second sub-set of the standardized episode data, wherein the set of features include at least one of price, quantity, volatility, and correlation between instruments, wherein the neural network is trained with historical episode data and historical market data, wherein the neural network comprises multiple layers of interconnected nodes;
identifying, by a second machine learning model, one or more decisions and determining a decision type of the one or more decisions, wherein the second machine learning model is trained based on historical episode data and corresponding decision data, wherein the decision data comprises identified decisions and decision types of the identified decisions for the historical episode data;
generating, by the processor, insights based on the set of features, the decision type of the one or more decisions, and a decision score of the one or more decisions;
calculating, by the processor, a final performance score for the portfolio manager based on the first performance score and the decision score of the one or more decisions; and
alerting, by the processor, the portfolio manager through a communication channel, wherein alerts comprise the final performance score and selectable actions comprising pausing trades for the portfolio manager to prevent the portfolio manager from making wrong decisions, wherein the alerts are modified based on portfolio manager's past interactions with the alerts.

2. The method of claim 1, wherein the episode data comprises one or more episodes, wherein an episode from the one or more episodes comprises a plurality of decisions, wherein the one or more episodes are determined based on one or more parameters.

3. (canceled)

4. The method of claim 3, wherein the neural network is configured to adjust assumptions around Threshold and Entry/Exit Window based on the portfolio manager's historical holdings data and the market liquidity data,
wherein Threshold is maximum length of scaling period during which the portfolio manager may gradually increase or decrease the quantity held of an instrument, and the Entry/Exit Window defines the time period within which the portfolio manager may enter or exit a position,
wherein the neural network is trained to predict an optimal Threshold and Entry/Exit Window to improve the accuracy of these predictions and enhance the portfolio performance.

5. The method of claim 3, wherein the island data is determined based on the holdings data and a machine learning algorithm.

6. (canceled)

7. The method of claim 1, wherein the decision score corresponds to the impact on a portfolio of the portfolio manager, and wherein the decision score is calculated based on the time-weighted return on investment of an asset over a period of the episode.

8. The method of claim 1, wherein the decision score is calculated based on the money-weighted return on investment of the instrument over the period of the episode.

9. (canceled)

10. The method of claim 1, wherein the decision type is determined by comparing the actual decisions with a baseline alternative.

11. The method of claim 1, wherein the insights include a ranking of the portfolio manager's decision-making performance relative to other portfolio managers.

12. (canceled)

13. (canceled)

14. (canceled)

15. The method of claim 1, wherein the insights generated include recommendations for improving future decision-making.

16. The method of claim 1, wherein the alerts generated are real-time alerts provided to the portfolio manager.

17. (canceled)

18. The method of claim 1, wherein the insights generated include a comparative analysis of the portfolio manager's performance against a benchmark.

19. The method of claim 1, further comprises generating a visual representation of the decision types and their respective impacts on the portfolio value.

20. The method of claim 1, further comprises providing a historical analysis of the portfolio manager's decision-making patterns over a specified period.

21. (canceled)

22. (canceled)

23. A system for reconstructing and normalizing incomplete time-series holdings data to improve time-series data integrity and to generate actionable insights comprising: a processor; and a memory storing instructions that, when executed by the processor, cause the system to:
receive holdings data comprising time-stamped quantities and prices for a plurality of instruments;
generate, by a trained episode reconstruction model, episode boundaries and gap segments for each instrument by computing, for each time interval between adjacent time-stamped records, a gap score indicative of a type of discontinuity, wherein the type of discontinuity includes a non-trading gap and a true discontinuity, wherein the trained episode-reconstruction model is trained by minimizing an objective loss function that includes at least a continuity-violation penalty for discontinuities within an episode, and an episode-boundary penalty for false splits or false merges, and wherein training comprises generating training labels for episode boundaries using automated consistency checks that enforce trading-calendar constraints and validate reconstructed values against subsequently observed holdings records;
select, based on the gap score and a configurable forward-fill horizon, a gap-handling operation comprising at least one of forward filling, interpolation, and creation of an episode boundary;
produce episode data that includes, for each episode, a continuous trading-day index that includes non-trading days within the continuous trading-day index;
post-process the episode data by at least applying corporate-action adjustments using a corporate-action sequence comprising timestamped adjustment factors for at least splits, dividends, mergers, and acquisitions, and converting monetary values into a base currency using stored foreign-exchange time-series data;
store the normalized episode data in a time-indexed data structure partitioned by at least instrument identifier and episode identifier, the time-indexed data structure configured for sequential access by downstream machine learning models; and
retrain the trained episode-reconstruction model using feedback derived from corrections to episode boundaries or gap-handling operations, wherein the corrections are stored as machine-readable boundary constraints.
